(19) United States
(12) Patent Application Publication
(10) Pub. No.: US 2015/0221445 A1
(43) Pub. Date: Aug. 6, 2015

(54) PHOTOASSISTED HIGH EFFICIENCY CONVERSION OF CARBON-CONTAINING FUELS TO ELECTRICITY

(71) Applicants: THE REGENTS OF THE UNIVERSITY OF CALIFORNIA, OAKLAND, CA (US); CALIFORNIA INSTITUTE OF TECHNOLOGY, PASADENA, CA (US)

(72) Inventors: Clifford P. Kubiak, Del Mar, CA (US); Mark J. Llorente, San Diego, CA (US); Nathan S. Lewis, La Canada, CA (US); Robert H. Coridan, Pasadena, CA (US); Anna R. Beck, Pasadena, CA (US)

(21) Appl. No.: 14/414,083

(22) PCT Filed: Jul. 10, 2013
(86) PCT No.: PCT/US2013/049976

§ 371 Date: Jan. 9, 2015

Related U.S. Application Data
(60) Provisional application No. 61/670,062, filed on Jul. 10, 2012.

(51) Int. Cl. H01G 9/20; H01M 8/10

(52) U.S. Cl. CPC H01G 9/20; H01M 8/10

(57) ABSTRACT

Electricity is generated by oxidizing a carbon-containing fuel in a photoelectrochemical fuel cell via a cyclic oxidation pathway to yield carbon dioxide and water, and collecting the electrons released via the cyclic oxidation pathway to yield a flow of electrons. The cyclic oxidation pathway includes a series of reactions of which is a photooxidation reaction. Photooxidation triggers one or more dark oxidation reactions, thereby increasing the efficiency of the photoelectrochemical fuel cell.

### CROSS-REFERENCE TO RELATED APPLICATION

This application claims priority to U.S. App. Ser. No. 61/670,062 entitled “Photoassisted High Efficiency Conversion of Liquid Fuels to Electricity” and filed on Jul. 10, 2012, which is incorporated by reference herein in its entirety.

### STATEMENT OF GOVERNMENT SUPPORT

This invention was made with government support under W911NF-09-02-0011 awarded by the Defense Advanced Research Projects Agency, an agency of the U.S. Department of Defense. The government has certain rights in the invention.

### TECHNICAL FIELD

This disclosure relates to photoelectrochemical fuel cells that utilize light and photoactive materials to achieve complete oxidation of carbon-containing fuels.

### BACKGROUND

Commercially available fuel cells, which typically use heat or electrochemical overpotentials to overcome reaction barriers, are largely incompatible with C2 and higher fuels unless operating at near-combustion temperatures. This limitation is due at least in part to the production of easily adsorbed catalyst-poisoning intermediates. These catalyst-poisoning intermediates are difficult to oxidize, and can lower the activity of thermal catalysts. Examples of such commercially available fuel cells include high-temperature fuel cells (e.g., solid-oxide fuel cells) and proton-exchange fuel cells (e.g., direct methanol fuel cells).

### SUMMARY

In a first general aspect, electricity is generated by oxidizing a carbon-containing fuel in a photoelectrochemical fuel cell via a cyclic oxidation pathway to yield carbon dioxide and water, and collecting the electrons released via the cyclic oxidation pathway to yield a flow of electrons. The cyclic oxidation pathway includes a series of reactions including oxidation reactions, at least one of which is a photooxidation reaction.

In a second general aspect, a photoelectrochemical fuel cell includes an anode compartment including a photoanode and a carbon-containing fuel, a cathode compartment including a cathode, and a proton exchange membrane separating the anode compartment and the cathode compartment. The photoelectrochemical fuel cell is configured to oxidize the carbon-containing fuel via a cyclic oxidation pathway to yield carbon dioxide and water and to collect the electrons released via the cyclic oxidation pathway to yield a flow of electrons. The cyclic oxidation pathway includes a series of reactions including oxidation reactions, wherein the oxidation reactions include at least one photooxidation reaction.

Implementations of the first and second general aspects may include one or more of the following features.

The carbon-containing fuel is in the liquid phase or the gas phase. The carbon-containing fuel may be, for example, an organic fuel or a hydrocarbon. In some cases, the carbon-containing fuel is selected from the group consisting of hydrocarbons, alcohols, aldehydes, acetals, carboxylic acids, sugars, carbohydrates, ketones, esters, and ethers. The carbon-containing fuel may have at least two carbon atoms. The series of reactions may include one or more of: photooxidation of a first carboxylic acid to yield a carbocation, formation of an alcohol from the carbocation, oxidation of the alcohol to yield an aldehyde, formation of a geminal diol or acetal from the aldehyde, and oxidation of the geminal diol or acetal to yield a second carboxylic acid. In certain cases, the series of reactions includes one or two photooxidation reactions. The oxidation reactions include at least one dark oxidation, and may include at least one oxidation reaction catalyzed by a metal catalyst or a molecular catalyst.

In certain cases, oxidizing the carbon-containing fuel includes sequentially removing carbon atoms from the carbon-containing fuel and/or repeating the series of reactions at least once. The series of reactions may include breaking one C—C bond of the carbon-containing fuel and forming CO₂. The carbon-containing fuel may be completely oxidized. Oxidizing the carbon-containing fuel via the cyclic oxidation pathway occurs under ambient thermal conditions, or in a temperature range between 0° C. and 100° C.

The thermodynamic efficiency of the conversion of the carbon-containing fuel to electricity exceeds the Carnot cycle limitation, or is at least 37%. The photoelectrochemical fuel cell may power a light source, and the light source may provide photons to the photoanode to initiate the at least one photooxidation reaction.

The photoanode may include a semiconductor. The semiconductor may have a valence band more positive than 1.5 eV versus a normal hydrogen electrode. In some cases, the photoanode includes a dark catalyst, such as a metal catalyst. For example, the photoanode may be a rotating ring disk electrode, with both a semiconductor and a metal catalyst. In certain cases, the photoelectrochemical fuel cell includes an additional anode proximate the photoanode, with the additional anode including a metal catalyst.

Advantages for the conversion of chemical energy to electrical energy via photoelectrochemical fuel cells as described herein can include high efficiency, quantum yields that can approach the number of electrons exchanged between the fuel and the anode, and the use of photogenerated deep valence band (VB) holes to oxidize kinetically stable carbon-containing fuels to protons and high energy organic radicals that then can undergo thermal electron transfer to the anode.

These general and specific aspects may be implemented using a device, system or method, or any combination of devices, systems, or methods. The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 depicts a cyclical oxidation pathway for complete oxidation of a carbon-containing fuel.

FIG. 2 depicts processes in a photoelectrochemical fuel cell (PEC).

FIG. 3 depicts a reaction pathway for complete oxidation of methanol.

FIGS. 4A-4F depict complete oxidation of methane and methanol in a PEC.

FIG. 5 depicts a PEC.

FIG. 6 depicts a device including PECs in series.

FIGS. 7A and 7B depict anodes suitable for PECs.

FIGS. 8A and 8B show dark current for oxidation of methanol, with and without photooxidation.

FIG. 9 shows dark current and photocurrent for oxidation of methanol with a rotating ring disk electrode.

FIG. 10 shows formaldehyde formation from bulk electrolysis on TiO₂.

FIG. 11 shows formaldehyde formation from bulk electrolysis on WO₃.

FIG. 12 shows bulk electrolysis of butyric acid on TiO₂.

FIG. 13 shows current multiplication in a PEC.

### DETAILED DESCRIPTION

Photoelectrochemical fuel cells (PECs) described herein utilize light and a photoanode including a semiconductor to achieve complete oxidation of carbon-containing fuels. Photon absorption by the semiconductor triggers electrochemical oxidation of the carbon-containing fuels, facilitating complete oxidation to final combustion products CO₂ and H₂O through a series of oxidation reactions in which photogenerated semiconductor valence band holes are utilized to activate carbon-hydrogen and carbon-carbon bonds with light rather than heat. By sequentially breaking down the oxidation process of carbon-containing fuels into smaller steps, electrons from the oxidation reactions can be collected using minimal photoenergy and without implementation of high temperature processes or electrochemical overpotential.

In some cases, PECs described herein target catalyst-poisoning intermediates with the combined action of co-localized photooxidation and dark oxidation. Where conventional fuel cells and combustion engines use heat or high overpotentials to overcome reaction barriers, the PEC photoanode uses light to overcome bond cleavage barriers and release the energy contained in the fuel under ambient thermal conditions (e.g., in a range between 0° C. and 100° C.). PECs described herein also demonstrate current multiplication, in which more than two electrons are driven through an external circuit per photon absorbed. This light-driven multiple electron oxidation can therefore operate at quantum efficiencies greater than two, boosting the efficiency of the PEC while operating under ambient thermal conditions.

PECs described herein include a photoanode, a cathode, and a proton exchange membrane positioned between the photoanode and the cathode. The photoanode includes one or more semiconductors capable of performing photooxidation. In some instances, the photoanode also includes one or more dark catalysts (e.g., metal catalysts, molecular catalysts, or the like) that facilitate electrochemical oxidation of a carbon-containing fuel without requiring absorption of a photon. In certain instances, the PEC includes a photoanode capable of performing light-driven oxidation and a second anode proximate the photoanode that includes one or more dark catalysts. Oxygen is reduced to water at the cathode.

Chemical mechanisms that occur in the PECs described herein include, but are not limited to: (1) multiple electron oxidation of carbon-containing fuels using multiple steps; (2) enhancement of internal photon to oxidative current quantum yields to above one on a semiconductor material (e.g., through the use of dark catalysts); and (3) a cyclical oxidation pathway for the complete oxidation of carbon-containing fuels. Conversion of the energy in the carbon-containing fuel to electricity includes current multiplication and overall thermodynamic efficiency exceeding Carnot cycle limitations.

Advantages for the conversion of chemical energy to electrical energy via PECs described herein can include: (1) quantum yields that can approach the number of electrons exchanged between the fuel and the anode (e.g., 8 for methane, 38 for hexane); and (2) the use of photogenerated deep valence band (VB) holes to oxidize kinetically stable carbon-containing fuels to protons and high energy organic radicals that then can undergo thermal electron transfer to the anode. In one example, a hydrocarbon fuel is oxidized by a hole from a photoexcited semiconductor in the photoanode. The singly oxidized hydrocarbon then fragments into a proton and an organic radical. The organic radical thermally injects an electron into the conduction band (CB) of the semiconductor. This produces another organic fragment which decomposes to form another proton and another high energy organic radical. While thermal deprotonation reactions form energetic organic species that are sufficiently reducing to inject electrons into the CB of the semiconductor, the semiconductor functions as an anode, harvesting the electrochemical energy directly from the carbon-containing fuel.

When a species in this series of electron transfers become too thermodynamically stable or kinetically slow to transfer electrons to the semiconductor CB, the photoexcited semiconductor holes will continue driving oxidation of a carbon-containing fuel. While running at ambient temperatures (e.g., temperatures between 0° C. and 100° C.) should inhibit or prevent the conversion of fuels to stable and highly carbonaceous materials (e.g., aromatics, coke, and the like), photogenerated holes deep in the VB of the semiconductor will decompose these stable materials to smaller, more reactive, and electrochemically active species should they form.

In one example, in the 38 electron electrochemical combustion of hexane to CO₂ and H₂O, 11 of the electrons for highly kinetically activated and thermodynamically demanding oxidation come from a UV irradiated photoanode (one photon process for each C—C bond and one photon process for one C—H bond per carbon), and the other 27 electrons are collected by dark oxidations of high energy organic radicals generated by the same photooxidations. Overall thermodynamic efficiency is calculated as maximum power output (38 electrons×1 eV) minus the minimum energy required for photoexcitation of the photoanode (11 electrons×2 eV indirect band gap) all divided by the hexane enthalpy (43 eV), or (38e⁻×1 eV-11e⁻×2.0 eV)/43 eV)×100%, or about 37%. If, however, 6 of the electrons come from a UV irradiated photoanode (one photon process for each C—C bond and one initial C—H bond) and the other 32 electrons are collected by dark oxidations of high energy organic radicals generated by the same photooxidations, overall thermodynamic efficiency is (38e⁻×1 eV-6e⁻×2.0 eV)/43 eV)×100%, or about 60%.

Unlike direct methanol fuel cells (DMFCs) which produce undesirable organic by-products like CO that can poison catalysts, the series of oxidations at a photoanode consumes unwanted organic species and radicals until complete conversion to carbon dioxide (CO₂), protons (H⁺), and energetic electrons (e⁻) is realized. As with a typical fuel cell, the protons are passed through a proton exchange membrane (PEM), and the electrons drive a load until they meet at the cathode to reduce oxygen (O₂) to water (H₂O). The maximum attainable voltage of the cell is the difference in potentials of the semiconductor CB and the oxygen reduction reaction at the cathode. For TiO₂, this yields a PEC voltage up to about 1.5 volts.

A cyclical oxidation pathway includes a series of oxidation reactions that successively break C—C bonds in the carbon-containing fuel to achieve complete oxidation of the carbon-containing fuel in the absence of high temperatures and electrochemical overpotential. As used herein, a “cyclical oxidation pathway” generally refers to a series of reactions including oxidation reactions, some or all of which may be repeated, to completely oxidize a carbon-containing fuel. In some instances, carbon atoms are removed from a carbon-containing fuel sequentially, from a first end to a second of a C—C chain.

A cyclical oxidation pathway typically includes one or more light catalysts (e.g., semiconductors) capable of photooxidizing a carbon-containing fuel. In some cases, an oxidation pathway also includes one or more dark catalysts (e.g., metal catalysts or molecular catalysts) to catalyze oxidation of carbon-containing fuels. An oxidation pathway that results in oxidation of a carbon-containing fuel and formation of CO₂ typically includes at least one photooxidation and may include one or more additional dark oxidations, with each oxidation typically transferring one or more electrons to the photoanode, or to another anode if present.

Suitable carbon-containing fuels include traditional fuel such as gasoline, diesel, and JP-8, each comprised of different mixtures of carbon-containing compounds that have chains of carbon-carbon bonds, or aromatic rings, as well as carbon-hydrogen bonds of the aliphatic or aromatic type. Other suitable carbon-containing fuels include alcohols, aldehydes, acetals, geminal diols, carboxylic acids, sugars, carbohydrates, ketones, esters, ethers, and the like. Oxidation reactions described herein may occur in the liquid or gaseous phase, with the transfer or presence of H₂O or OH⁻ suitable to achieve complete oxidation of the carbon-containing fuel to CO₂. In some cases, oxidation reactions described herein occur in an aqueous medium. Reaction rates may be enhanced under acidic or basic conditions. The carbon-containing fuel may be present in a wide range of concentrations (e.g., 1 mM to 50 vol %).

Suitable photoanodes include a semiconductor capable of photooxidation of a carbon-containing fuel. Suitable semiconductors typically have a band gap between the valence band and the conduction in a range between 2 eV (e.g., Fe₂O₃) and 4 eV (e.g., SnO₂). In some cases, the semiconductor has a valence band more positive than 1.5 eV versus a normal hydrogen electrode (NHE). A more positive (lower) conduction band indicates that the photocatalyst may be thermodynamically capable of collecting more electrons without the use of light, thus leading to greater quantum yields. The semiconductor may be present in the form of an oxide (e.g., TiO₂, WO₃, Fe₂O₃, SnO₂, SrTiO₃, ZnO), a sulfide (e.g., CuS, and Cu₂S), a nitride (e.g., GaN, C₃N₄), a phosphide (e.g., GaP, GaInP, InP), and an arsenide (e.g., GaAs, BAs), or combinations thereof. In some cases, doping can lead to the formation of new lower bands below the original conduction band. If the conduction band is low enough, the semiconductor may be used to collect all of the electrons in the oxidation process, thus reducing complexity of the anode and reducing the light energy needed for excitation. Suitable dark catalysts include metal catalysts such as Pt, Au, Pd, Cu, Ru, and alloys and nanoparticles thereof. Suitable dark catalysts also include molecular catalysts such as Ni(P₂N₂)₂, Ni-cyclam, and various transition metal oxidation catalysts.

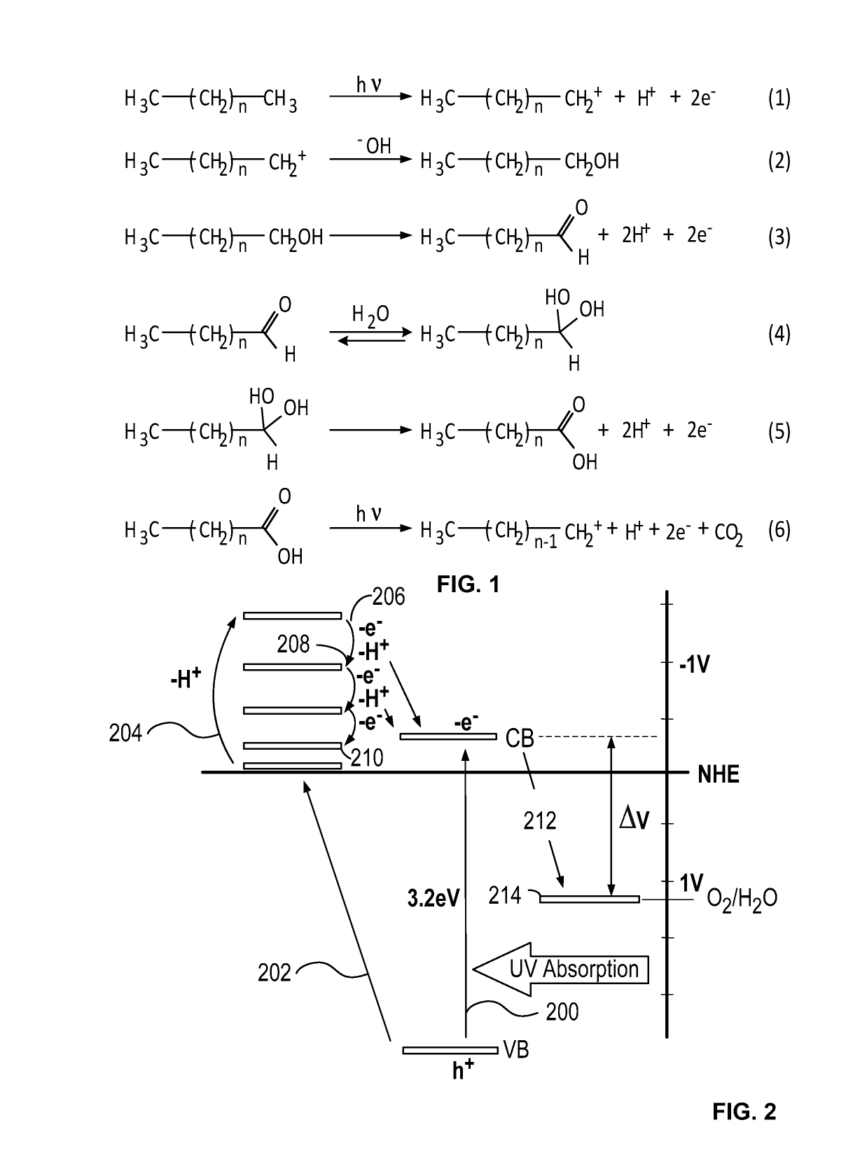

FIG. 1 depicts a cyclical oxidation pathway for complete oxidation of carbon-containing fuels. Reactions (1)-(6) of the oxidation pathway depict the removal of one carbon atom from a hydrocarbon fuel having n+2 carbon atoms to yield carbon dioxide and a hydrocarbon fuel having n+1 carbon atoms. Some or all of the reactions in the cyclical oxidation pathway may be repeated sequentially to achieve complete oxidation of a carbon-containing fuel, where “carbon-containing fuel” is understood to refer to the primary carbon-containing fuel (in this case, the hydrocarbon having n+2 carbon atoms) as well as any carbon-containing compound formed as a result of Reactions (1)-(6).

In Reaction (1), photooxidation of the hydrocarbon fuel results in the formation of a carbocation and the release of two electrons. In Reaction (2), the carbocation formed in Reaction (1) forms an alcohol. In Reaction (3), the alcohol is oxidized to yield an aldehyde and two electrons. In Reaction (4), the aldehyde forms a geminal diol. In Reaction (5), the diol is oxidized to yield a carboxylic acid. In Reaction (6), photooxidation of the carboxylic acid yields CO₂ and a carbocation with n+1 carbon atoms. Reaction (6) may include photocatalytic decarboxylation via the photo-Kolbe reaction. The carbocation from Reaction (6) may then form an alcohol via Reaction (2), and oxidation continues via cyclical repetition of Reactions (2)-(6) until formic acid (CH₂O₂) is produced via Reaction (5). Formic acid, having only one carbon atom, does not undergo Reaction (6), but rather decomposes in the presence of a catalyst (e.g., Ni(P₂N₂)₂) to yield H₂ and CO₂. In one example, when n=4 and the hydrocarbon fuel is hexane, complete oxidation via the cyclical oxidation pathway includes absorption of 6 photons and yields 6 CO₂, 7 H₂O, and 38 electrons.

Although the cyclical oxidation pathway in FIG. 1 depicts oxidation of a carbon-containing fuel sequentially from a first end to a second end, oxidation may also occur in non-terminal positions along a carbon chain, yielding intermediate carbon-containing compounds that subsequently undergo complete oxidation. In one example, photooxidation of butyric acid by TiO₂ breaks the C—C bond to yield isopropanol and acetone. Isopropanol may current double at TiO₂ or may be oxidized in a dark oxidation process that does not require photon absorption. Acetone is formed upon the oxidation of isopropanol.

While the cyclical oxidation pathway in FIG. 1 begins with oxidation of a hydrocarbon fuel, other carbon-containing fuels may also undergo complete oxidation via this or other pathways. In one example, when the fuel is an alcohol, the alcohol is oxidized beginning at Reaction (3). In another example, when the fuel is an aldehyde, the aldehyde is oxidized beginning at Reaction (4). In yet another example, when the fuel is a geminal diol or acetal, the geminal diol or acetal is oxidized starting with Reaction (5). In yet another example, when the fuel is a carboxylic acid, the carboxylic acid is oxidized starting with Reaction (6). Moreover, although pathway 100 is depicted for a carbon-containing fuel having at least two carbon atoms, C1 fuels may also be oxidized to CO₂ via the cyclical oxidation pathway shown in FIG. 1.

FIG. 2 depicts operation of an exemplary PEC, with oxidation of a carbon-containing fuel broken into steps. At 200, a photoanode including a semiconductor is photoexcited upon UV absorption, with promotion of an electron from the valence band to the conduction band. At 202, hole transfer oxidizes the carbon-containing fuel. At 204, the oxidized carbon-containing fuel is deprotonated, yielding an energetic organic radical. At 206, electron transfer into the semiconductor conduction band is coupled with continued deprotonation 208. At 210, electron transfer ends in a kinetically slow or thermodynamically stable species for further electron transfer, which is then directed toward complete oxidation by repeating 200-210, as necessary to achieve complete oxidation. At 212, an external load is driven with the conduction band electrons, and at 214, O₂ is reduced to H₂O. As depicted, the process has a maximum quantum yield of 4. The light required can be generated from a light emitting diode (LED) that is powered by the fuel cell. The light energy is fed directly back into the system where some of that energy is recouped as electrical energy while simultaneously driving the reaction.

Thermodynamically, as a deep hole oxidizes a carbon-containing fuel and produces a proton, a highly energetic radical is also produced. If the radical adsorbs onto the photoanode, it can undergo efficient electron transfer to form the cation by electron injection into the conduction band. Two electrons have been contributed to the overall current: one by photooxidation and one by a thermal chemical reaction. With suitable catalysts, the radical dissociates to another proton and a second radical species which then thermally injects additional electrons into the conduction band, further multiplying the quantum yield.

As described herein, a PEC directs a minimum number of photogenerated holes to have the maximum effect in the combined photochemical and thermal oxidation of the fuel. At high light intensities, it is expected that the concentration of photogenerated holes would be high, and the entire oxidation of the fuel would be photochemical, and thus inefficient. Under low light intensity, photocurrents can be multiplied by thermal electron transfer reactions downstream of the photoelectrochemical oxidation. These reactions will continue until a rate limiting chemical reaction prevents further electron transfer. The introduction of another photogenerated hole reactivates the slow step, and the reaction continues. Thus, higher quantum yields can be obtained at lower light intensities, such that lowering the power given to the light source driving the reaction increases the energy conversion efficiency of the carbon-containing fuel. Operation of a PEC as described with respect to FIG. 2 includes efficient absorption of light to generate valence band holes to initiate activation of strong C—H and C—C bonds, efficient conduction band charge collection from reactive hydrocarbon fragments formed by photooxidation, and efficient mass transport of fuel through the anode compartment of the PEC.

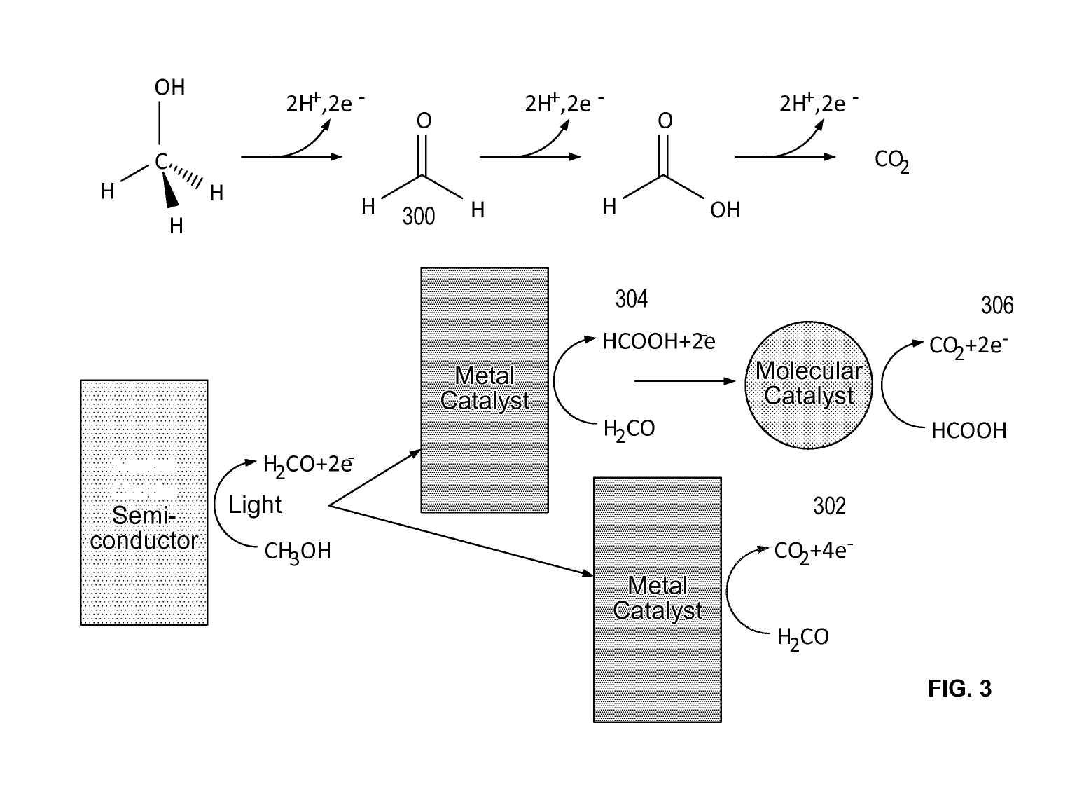

FIG. 3 depicts oxidation of methanol via a series of oxidation reactions that yields CO₂. A single photon initiates the oxidation of methanol via a photoanode to yield formaldehyde 300 and two electrons. The photoanode includes a semiconductor such as, for example, TiO₂, WO₃, SrTiO₃, MoS₂, or WSe₂. These two electrons, referred to herein as “photocurrent,” are collected by the photocatalyst for a single absorbed photon. In some implementations, the formaldehyde is oxidized directly to CO₂ via a dark oxidation, yielding four electrons 302 referred to herein as “dark current.” In other implementations, the formaldehyde is oxidized to formic acid 304 by a metal catalyst, and the formic acid is oxidized by a molecular catalyst to yield two additional electrons 306 for a total of four electrons, also referred to herein as “dark current.” Suitable metal catalysts for dark oxidation include Pt, Au, Pd, and the like, and suitable molecular catalysts include NiP₂N₂ and the like.

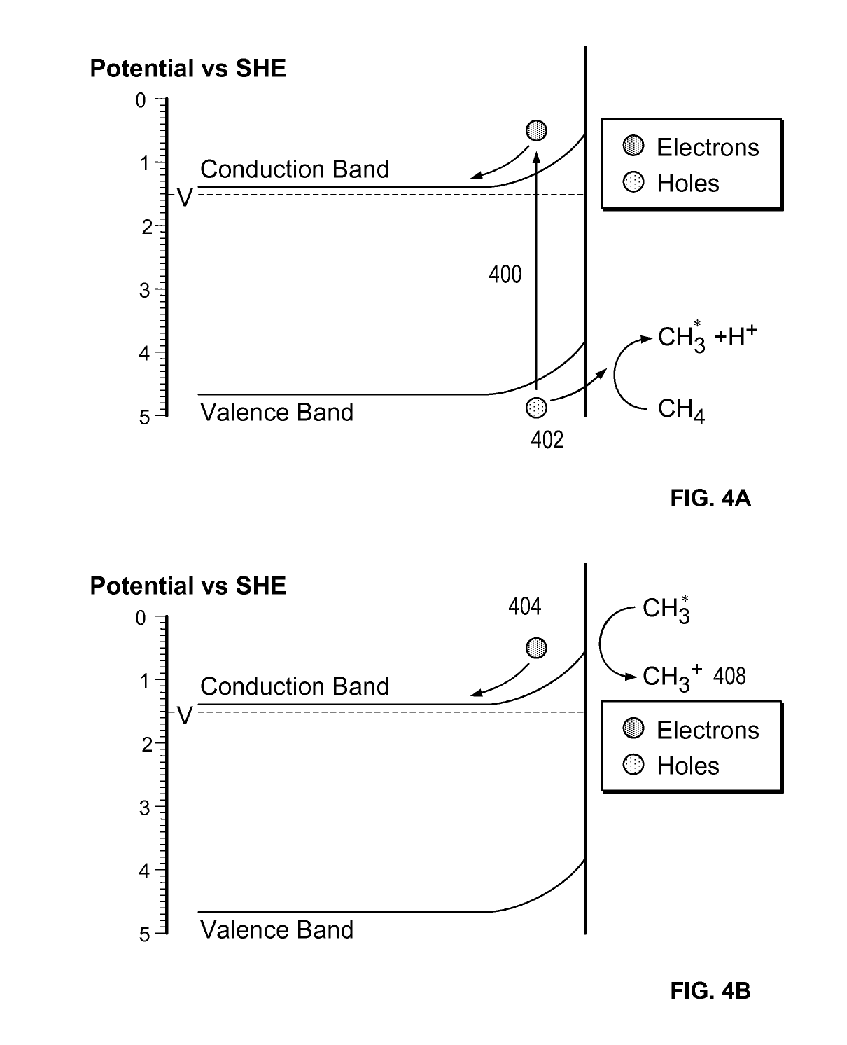

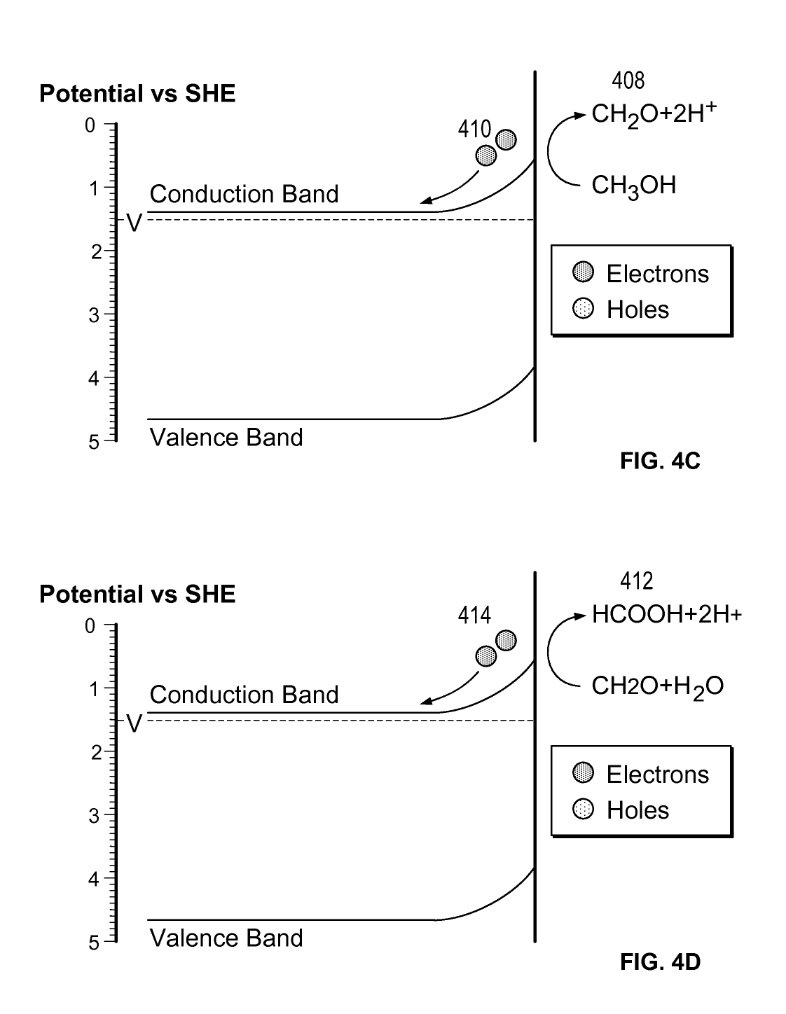

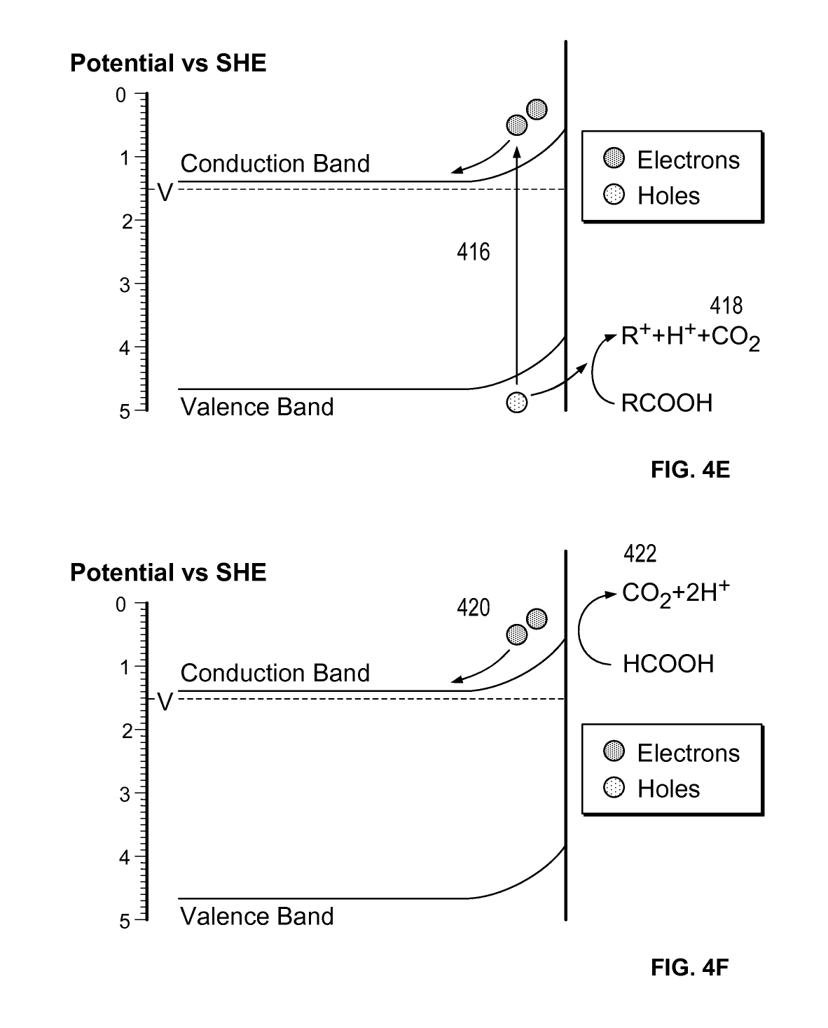

Complete oxidation of methane to carbon dioxide in a PEC is depicted in FIGS. 4A-4F, with complete oxidation of methanol depicted in FIGS. 4C-4F. FIG. 4A depicts photooxidation of methane, in which the photoanode semiconductor is photoexcited 400 upon UV absorption, with promotion of an electron from the valence band to the conduction band. Hole transfer 402 oxidizes the methane, and the oxidized methane is deprotonated, yielding a methyl radical. In FIG. 4B, dark injection or electron transfer 404 from the methyl radical into the semiconductor conduction band accompanies formation of a methyl carbocation 406. The methyl carbocation subsequently reacts with water to form methanol. FIG. 4C depicts alcohol dark oxidation, in which methanol is oxidized to formaldehyde 408, and two electrons 410 are released into the conduction band. In FIG. 4D, formaldehyde is oxidized to formic acid 412, and two more electrons 414 are released into the conduction band. In some embodiments, as shown in FIG. 4E, the formic acid is photooxidized via a photo Kolbe reaction with current doubling 416 to yield carbon dioxide 418. In other embodiments, as shown in FIG. 4F, dark oxidation of formate occurs, with two additional electrons released into the conduction band 420 and formation of carbon dioxide 422.

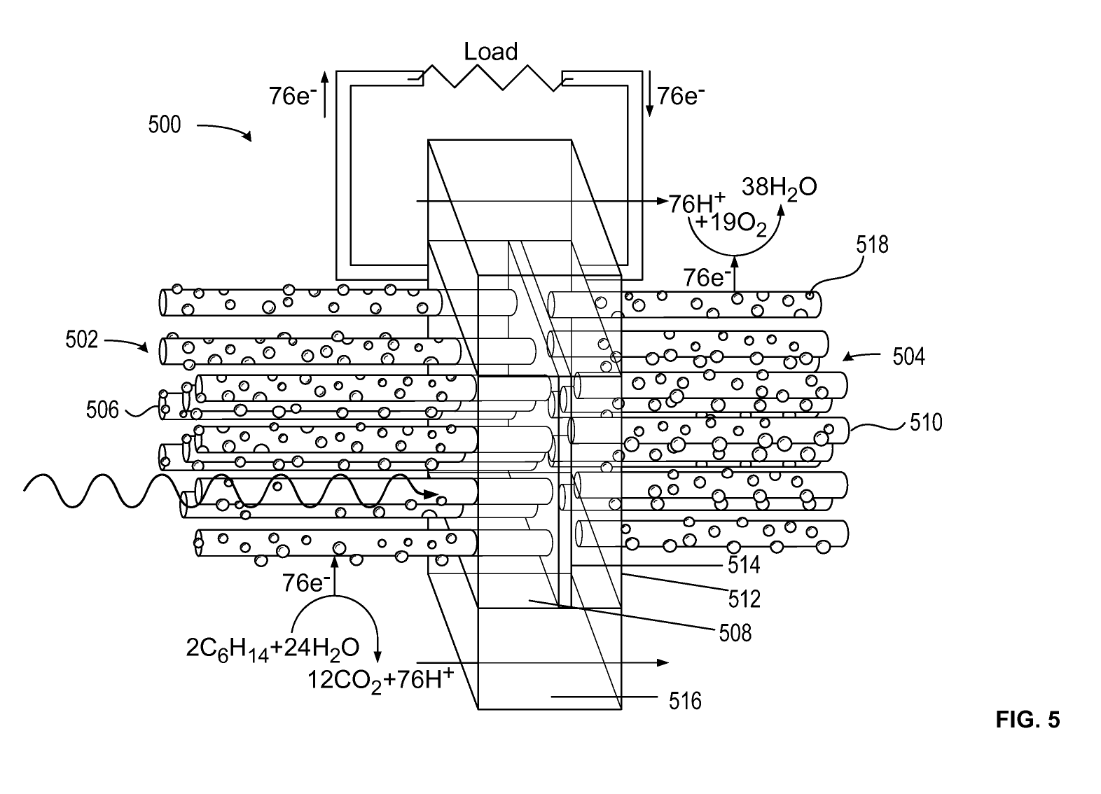

FIG. 5 depicts operation of PEC 500 utilizing hexane as fuel in accordance with one embodiment. PFC 500 includes anode compartment 502 and cathode compartment 504. Anode compartment 502 includes photoanode 506 coupled to conductive contact 508, and cathode compartment 504 includes cathode 510 coupled to conductive contact 512. Conductive contacts 508 and 512 are separated by insulator 514. Photoanode 506 and cathode 510 are depicted as arrays separated by proton exchange membrane 516 to allow for protons to transport between the anode compartment 502 and the cathode compartment 504. Photoanode 506 and cathode 510 are in the form of a silicon array, coated with a semiconductor such as TiO₂ or WO₃, with metal catalyst particles (e.g., Au or Cu) 518 disposed on the surface of the semiconductor. As depicted in FIG. 5, hexane is completely oxidized to carbon dioxide and water, with electrons and protons from the oxidation reactions flowing from the anode compartment to the cathode compartment.

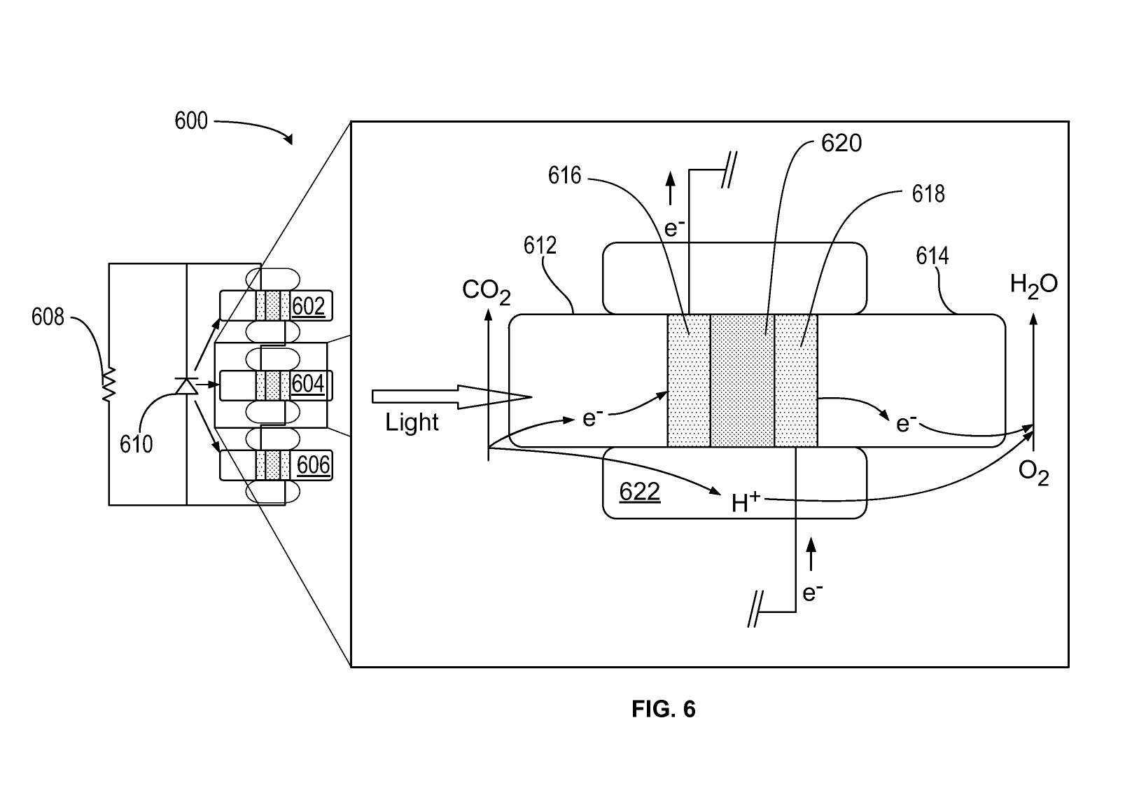

FIG. 6 depicts device 600 with PECs 602, 604, and 606 in series, including an expanded view of PEC 604. PECs 602, 604, and 606 are coupled to power load 608. Some embodiments of device 600 include LED 610, which irradiates PECs 602, 604, and 606 to drive the oxidation of a carbon-containing fuel. Other embodiments do not include the LED, and are irradiated with an external light source. The expanded view of PEC 604 depicts anode compartment 612 and cathode compartment 614. Anode compartment 612 includes photoanode 616 and cathode compartment 614 includes cathode 618. Photoanode 616 and cathode 618 are separated by insulator 620.

Anode compartment 612 and cathode compartment 614 are separated by proton exchange membrane 622 to allow for transportation of protons between the fluid medium in the anode compartment 612 and the fluid medium in the cathode compartment 614. Metal catalyst particles (e.g., Au or Pt nanoparticles) may be disposed on photoanode 616 and cathode 618. During operation of device 600, light, carbon-containing fuel, and water are delivered to anode compartment 612. In some embodiments, light is provided by LED 610. In other embodiments, light is provided by an external light source. The carbon-containing fuel in the fluid medium in anode compartment 612 decomposes under current multiplication conditions as described herein. The protons pass through the proton exchange membrane 622. When device 600 includes LED 610, the electrons drive the load 608 and the LED. The protons and electrons reduce oxygen to water in the cathode compartment 614.

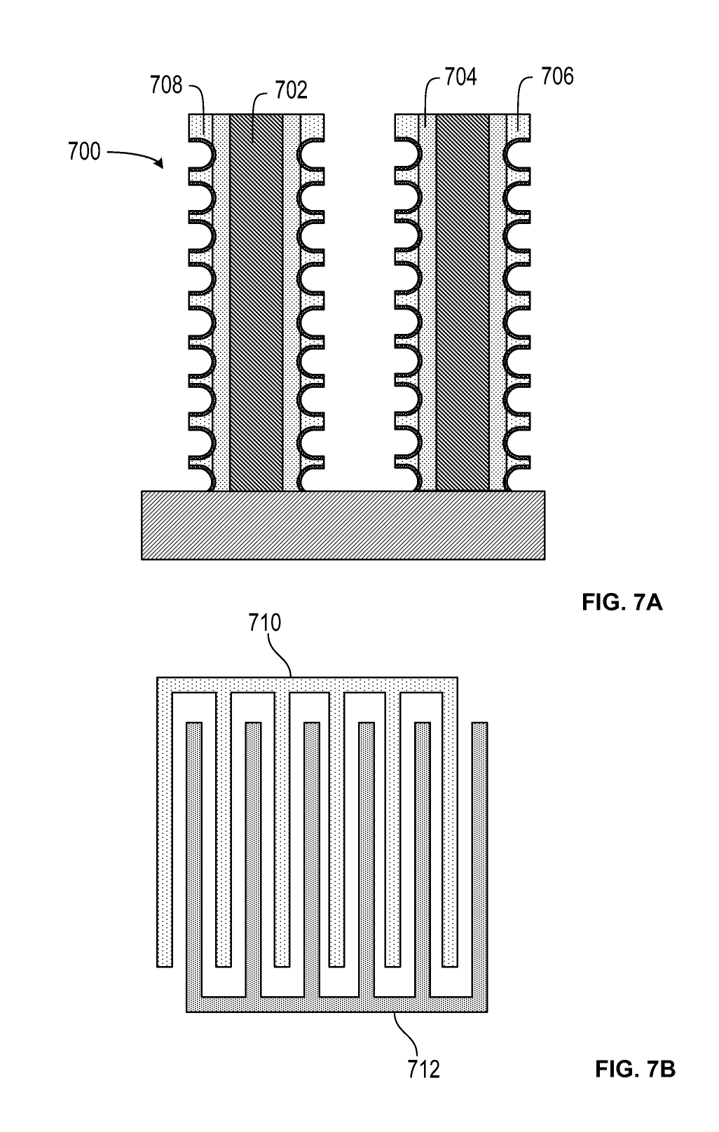

In some cases, photoanode 616 includes a semiconductor as well as one or more dark catalysts (e.g., metal catalysts, molecular catalysts, or a combination thereof) disposed on the photoanode. The photoanode may be in the form of an array (e.g., a wire array, a microwire array, a nanowire array, or the like), a planar structure, a cylindrical structure, or a rotating ring disk. In one example, shown in FIG. 7A, anode 700 is a wire array, with silicon wires 702 surrounded by a layer of indium tin oxide 704, with semiconductor 706 and dark catalyst 708 disposed thereon.

In certain cases, a PEC includes a photoanode as well as an additional anode including one or more dark catalysts (e.g., metal catalysts, molecular catalysts, or a combination thereof). The photoanode and the additional anode may be positioned proximate each other (e.g., with a separation of 3 cm or less) to allow photooxidized fuel intermediates to diffuse to and be oxidized by the dark catalyst anode. FIG. 7B depicts a photoanode 710 positioned proximate an electrically decoupled anode 712, with photoanode 710 including a semiconductor and anode 712 including a dark catalyst. Photoanode 710 and anode 712 are positioned proximate each other (e.g., interdigitated) such that photooxidized fuel intermediates from photoanode 710 can diffuse to and be oxidized at anode 712. With photoanode 710 and anode 712, electrons that cannot be thermodynamically injected into the conduction band of the semiconductor on photoanode 710 can be collected by the dark catalyst on anode 712. Advantages of this approach can include the modular nature of the electrodes (interchangeable for optimization of catalyst compatibility), fewer restrictions on the conduction band, and the ability to run the different anodes at different potentials to optimize electron collection. In addition, the dark catalyst anode is directly compatible with molecular catalysts.

Cathode 620 may have a structure generally known in the art. In some cases, cathode 620 includes a metal catalyst to facilitate formation of H₂O.

### EXAMPLES

The following examples are provided to more fully illustrate some of the embodiments of the present disclosure. However, those of skill in the art should, in light of the present disclosure, appreciate that many changes can be made in the specific embodiments that are disclosed without departing from the spirit and scope of the invention.

### Example 1

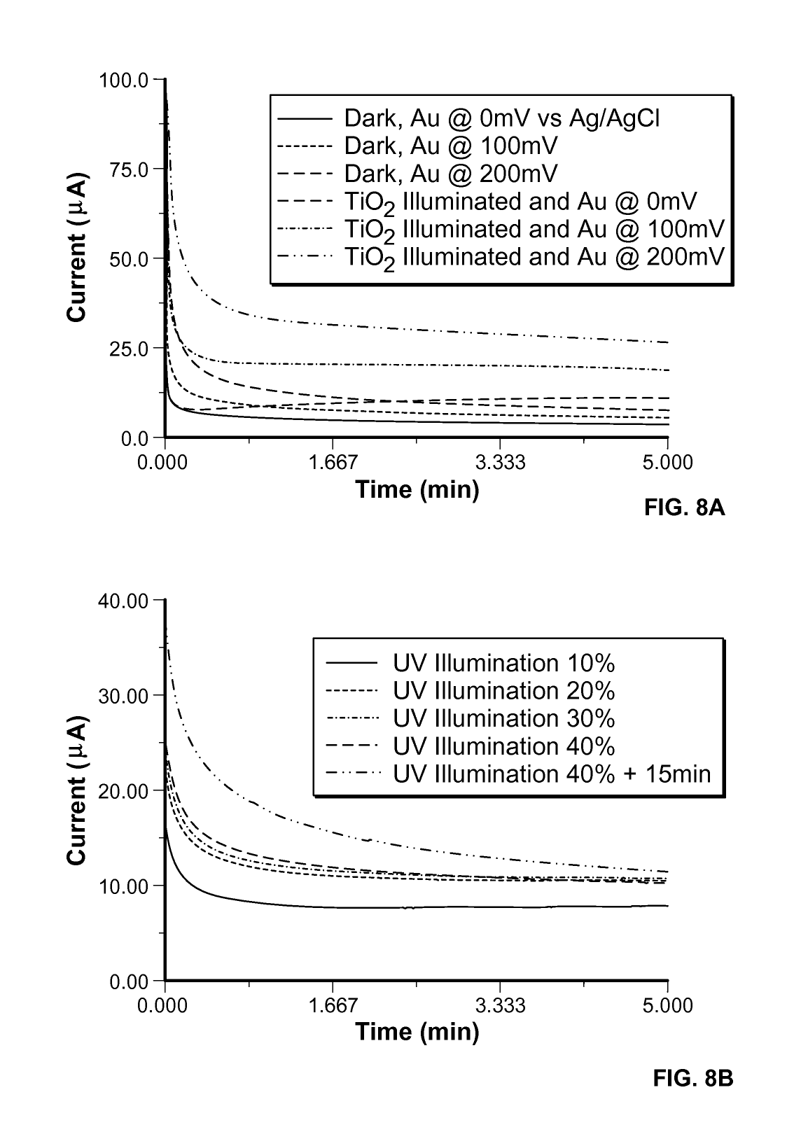

FIGS. 8A and 8B show dark current, with and without photooxidation, for oxidation of methanol (20%, pH 13) with Au as a dark catalyst anode proximate a TiO₂ electrode. FIG. 8A shows the oxidation of methanol at 0 mV, 100 mV, and 200 mV vs Ag/AgCl, respectively, without illumination, as well as the dark current at 0 mV, 100 mV, and 200 mV vs Ag/AgCl, with illumination of the TiO₂ electrode. As shown, methanol alone has very little activity on Au, even at 200 mV vs the Ag/AgCl reference electrode. Upon illumination, dark current at 0 mV vs Ag/AgCl increases to higher than any of the dark currents without illumination.

FIG. 8B shows the dark current at the Au electrode with light intensity of 10%, 20%, 30%, 40%, and 40%+15 min of illumination before collecting current. Increasing light intensity at the photoanode corresponds to increasing dark current at the Au anode, however, the concentration of formaldehyde near the Au electrode influences the size of the dark current more than the light intensity. The plots for 40% and 40%+15 min of illumination have the same light intensity, but the photoanode in the latter was allowed to oxidize the methanol for 15 minutes. As time along the x axis increases, these plots approach the same current, suggesting that better transportation of formaldehyde to the Au anode facilitates efficient decomposition of the fuel.

### Example 2

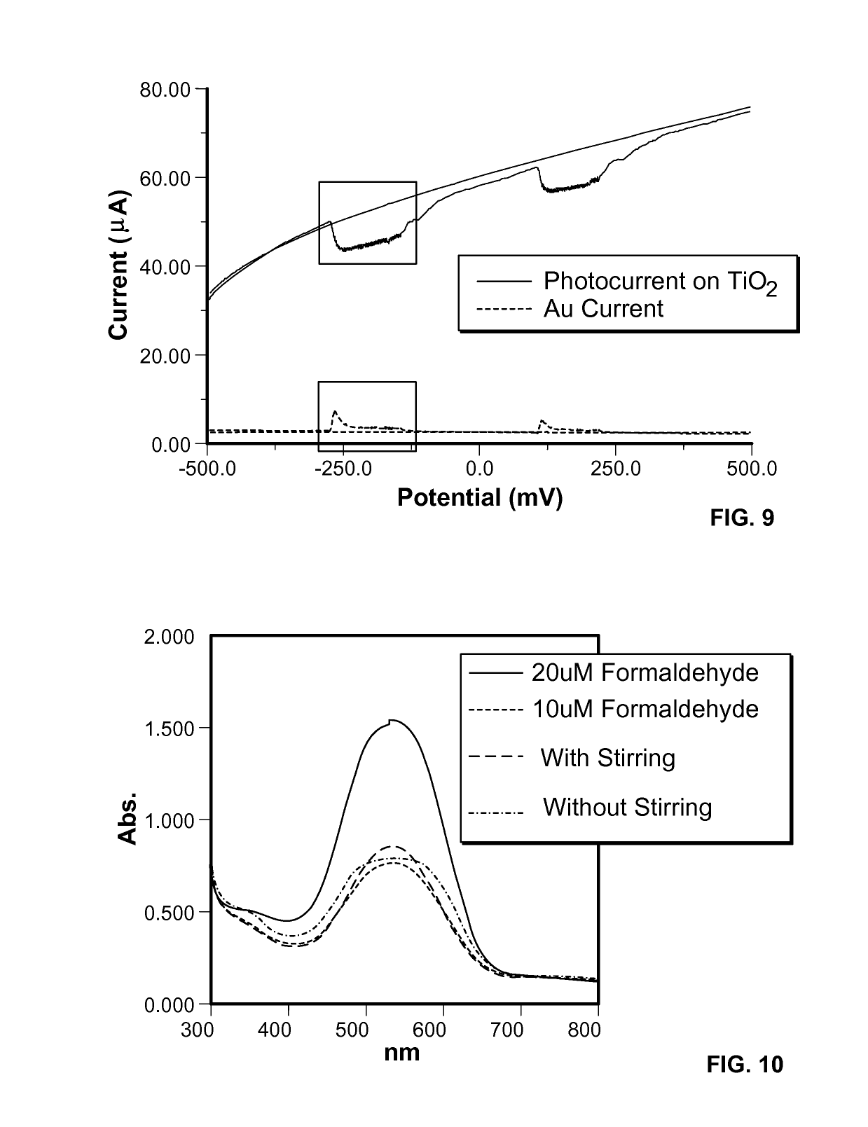

FIG. 9 shows dark current and photocurrent for oxidation of methanol (0.6M) in a basic solution (0.1M NaOH) with a TiO₂ disk/Au ring rotating ring disk electrode (˜10 mW/cm² illumination). As seen from the plots, the photocurrent drops and the dark current increases with rotation of the electrode.

### Example 3

FIG. 10 shows formaldehyde formation from bulk electrolysis on a nearly planar TiO₂ anode formed from 500 nm of Ti oxidized at 500° C. for three hours. Carbon-containing fuel was present as 40 mM methanol in 30 mL solution. Spectrographs of solutions containing Pupald, a formaldehyde selective assay reagent, are shown for 20 μM formaldehyde and 10 μM formaldehyde. Spectrographs of solutions containing Pupald with stirring, diluted ×5, 2.6 C passed (maximum of 13.5 μmol formaldehyde, ˜1.65 μmol formaldehyde formed) and without stirring, diluted ×5, 3.4 C passed (maximum of 17.6 μmol formaldehyde, ˜1.5 μmol formaldehyde formed) are also shown. Stirring releases ˜1.4× formaldehyde/charge passed as compared to no stirring.

### Example 4

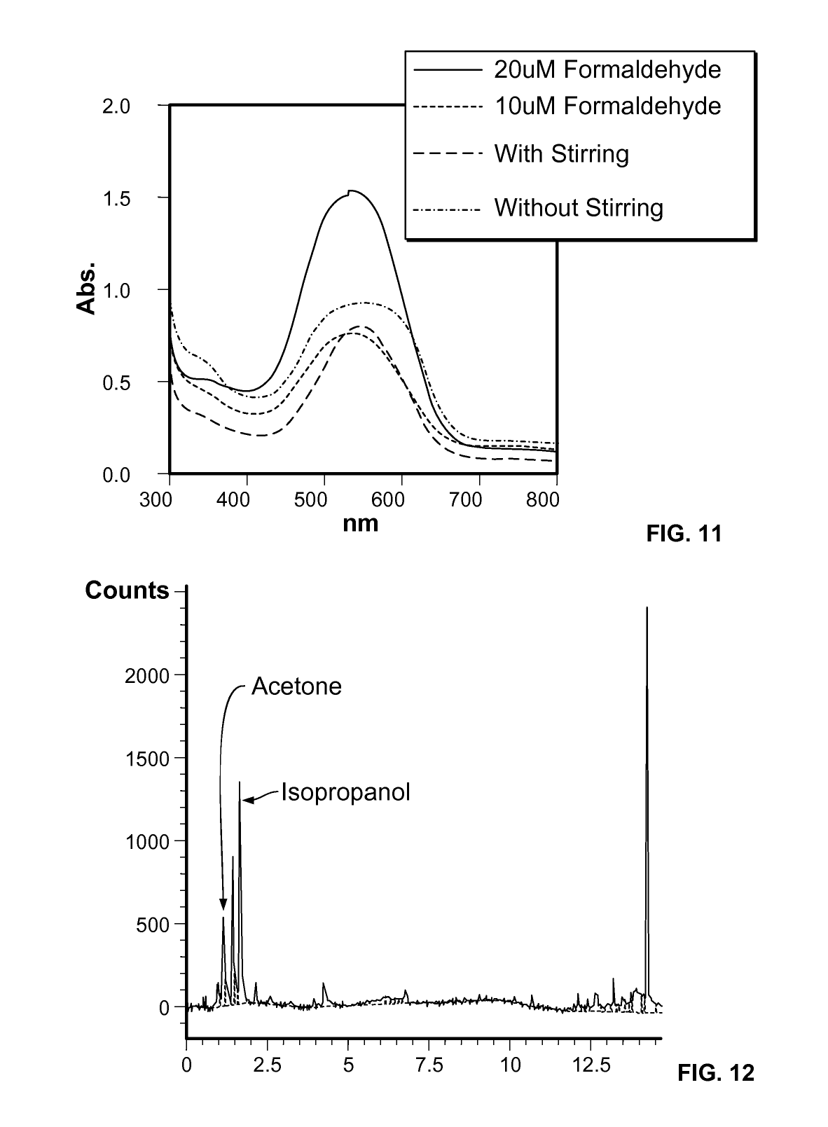

FIG. 11 shows formaldehyde formation from bulk electrolysis sol-gel WO₃ on indium tin oxide (pH 1, 40 mM methanol in 30 mL solution). Spectrographs of solutions containing Pupald, for 20 μM formaldehyde and 10 μM formaldehyde are shown. Spectrographs of solutions containing Pupald, with stirring, diluted ×3, 1.2 C passed (maximum of 12.4 μmol formaldehyde, ˜1 μmol formaldehyde formed) and without stirring, 1 C passed (maximum of 10.3 μmol formaldehyde, 0.4 μmol formaldehyde formed) are also shown. Stirring releases ˜1.9× formaldehyde/charge passed as compared to no stirring.

### Example 5

FIG. 12 shows products formed from bulk electrolysis of butyric acid on TiO₂ at pH 13. Gas chromatograph peaks are seen for isopropanol (2.0 μmol and acetone (2.1 μmol). Isopropanol is the first oxidation product after C—C activation of butyrate, and acetone is the product formed from oxidation of the alcohol. The charge passed, 1.4 C, corresponds to about 7 μmol of electrons.

### Example 6

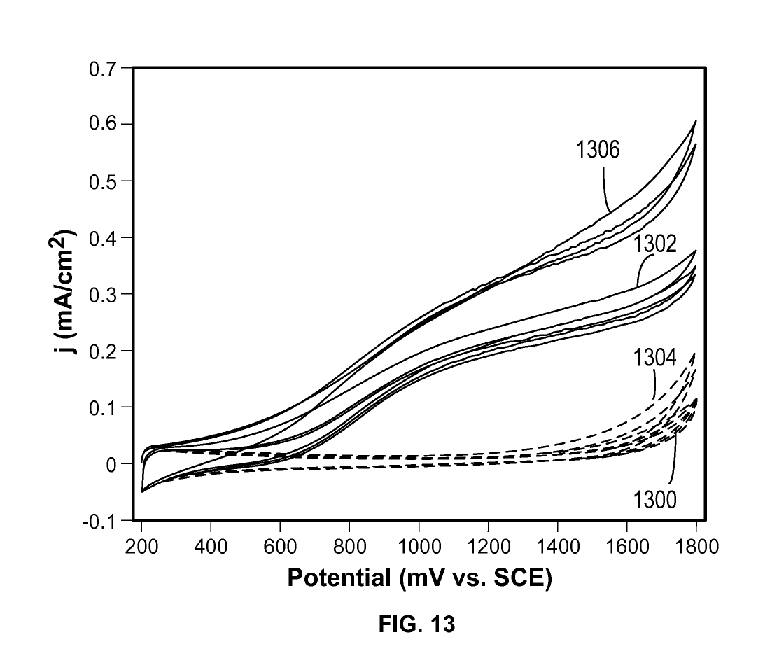

FIG. 13 shows current multiplication in the presence of methanol (1% in 1M H₂SO₄) in a PEC with a polysilicon microwire/ITO/WO₃ photoanode. Plots 1300 show cyclic voltammograms for baseline electrochemical response in the dark (aqueous sulfuric acid, no methanol). Plots 1302 show baseline photocurrent density vs. voltage (aqueous sulfuric acid, no methanol), with the photocurrent corresponding to water oxidation. Plots 1304 show electrochemical response in the dark (aqueous sulfuric acid, 1% methanol), and plots 1306 show the corresponding photocurrent. Plots 1306 show doubling of the current density vs. voltage when methanol is added. This is the result of a normal photocurrent being supplemented by a dark oxidation process that is coupled to the photooxidation.

Potential applications for a fuel cell designed in accordance with various embodiments include, but are not limited to the following: the transportation sector, where higher-efficiency engines may reduce consumer load on petroleum; the military sector, where omni-fuel and/or omni-vehicle engines may be used to streamline fuel transportation and engine scale-up; and small, portable devices, where small, high-efficiency electrical devices may be used for mobile or remote applications.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

What is claimed is:

1. A method of generating electricity from a carbon-containing fuel in a photoelectrochemical fuel cell, the method comprising:
oxidizing a carbon-containing fuel via a cyclic oxidation pathway to yield carbon dioxide and water; and
collecting the electrons released via the cyclic oxidation pathway to yield a flow of electrons,
wherein the cyclic oxidation pathway comprises a series of reactions comprising oxidation reactions, wherein the oxidation reactions comprise at least one photooxidation reaction.

2. The method of claim 1, wherein the thermodynamic efficiency of the conversion of the carbon-containing fuel to electricity is at least 37%.

3. The method of claim 1, wherein the series of reactions comprises photooxidation of a first carboxylic acid to yield a carbocation.

4. The method of claim 3, wherein the series of reactions further comprises formation of an alcohol from the carbocation.

5. The method of claim 4, wherein the series of reactions further comprises oxidation of the alcohol to yield an aldehyde.

6. The method of claim 5, wherein the series of reactions further comprises formation of a geminal diol from the aldehyde.

7. The method of claim 6, wherein the series of reactions further comprises oxidation of the geminal diol to yield a second carboxylic acid.

8. The method of claim 1, wherein the carbon-containing fuel is a carbon-containing compound comprising at least two carbon atoms.

9. The method of claim 1, wherein the carbon-containing fuel is an organic fuel or a hydrocarbon.

10. The method of claim 1, wherein oxidizing the carbon-containing fuel via the cyclic oxidation pathway occurs under ambient thermal conditions.

11. The method of claim 1, wherein the series of reactions comprises a single photooxidation reaction.

12. The method of claim 1, wherein the series of reactions comprises one or two photooxidation reactions.

13. The method of claim 1, wherein the carbon-containing fuel is a liquid.

14. The method of claim 1, wherein oxidizing the carbon-containing fuel comprises sequentially removing carbon atoms from the carbon-containing fuel.

15. The method of claim 1, wherein oxidizing the carbon-containing fuel via the cyclic oxidation pathway comprises repeating the series of reactions at least once.

16. The method of claim 1, wherein the series of reactions comprises breaking one C—C bond of the carbon-containing fuel and forming CO₂.

17. The method of claim 1, wherein oxidizing the carbon-containing fuel comprises completely oxidizing the carbon-containing fuel.

18. The method of claim 1, wherein at least a portion of the flow of electrons is provided to a light source, wherein the light source initiates the at least one photooxidation reaction.

19. The method of claim 1, wherein the oxidation reactions comprise at least one oxidation reaction catalyzed by a metal catalyst or a molecular catalyst.

20. A photoelectrochemical fuel cell comprising:
an anode compartment comprising a photoanode and a carbon-containing fuel;
a cathode compartment comprising a cathode; and
a proton exchange membrane separating the anode compartment and the cathode compartment,
wherein the photoelectrochemical fuel cell is configured to oxidize the carbon-containing fuel via a cyclic oxidation pathway to yield carbon dioxide and water and to collect the electrons released via the cyclic oxidation pathway to yield a flow of electrons, and
wherein the cyclic oxidation pathway comprises a series of reactions comprising oxidation reactions, wherein the oxidation reactions comprise at least one photooxidation reaction.

21. The photoelectrochemical fuel cell of claim 20, further comprising a light source, wherein the light source is powered by the photoelectrochemical fuel cell and the light source provides photons to the photoanode to initiate the at least one photooxidation reaction.

22. The photoelectrochemical fuel cell of claim 20, wherein the photoanode comprises a semiconductor.

23. The photoelectrochemical fuel cell of claim 22, wherein the photoanode further comprises a metal catalyst.

24. The photoelectrochemical fuel cell of claim 20, wherein the anode compartment further comprises an additional anode proximate the photoanode, wherein the additional anode comprises a metal catalyst.
